(19) United States
(12) Patent Application Publication
(10) Pub. No.: US 2023/0403513 A1
(43) Pub. Date: Dec. 14, 2023

(54) ELECTROSTATIC TRANSDUCER AND METHOD OF MANUFACTURING ELECTROSTATIC TRANSDUCER

(71) Applicant: TOHOKU UNIVERSITY, Sendai-shi, Miyagi (JP)

(72) Inventors: Shuji TANAKA, Sendai-shi (JP); Yukio SUZUKI, Sendai-shi (JP)

(73) Assignee: TOHOKU UNIVERSITY, Sendai-shi, Miyagi (JP)

(21) Appl. No.: 18/033,415

(22) PCT Filed: Oct. 26, 2020
(86) PCT No.: PCT/JP2020/040080

§ 371 Date: Apr. 24, 2023

(51) Int. Cl. H04R 19/00; H04R 19/04

(52) U.S. Cl. CPC H04R 19/005; H04R 19/04; H04R 2201/003

(57) ABSTRACT

An electrostatic transducer including a displacement plate having a fixed portion fixed to a support and a fluctuating portion provided so as to freely fluctuate with respect to the fixed portion. At least a portion of a detection means is attached to the fluctuating portion so as to freely fluctuate together with the fluctuating portion, and is provided so as to be able to detect the fluctuation of the fluctuating portion as a change in electrostatic capacitance. The detection means is arranged in a vacuum or low-pressure space.

### FIELD OF THE INVENTION

The present invention relates to an electrostatic transducer and a method of manufacturing the electrostatic transducer.

### DESCRIPTION OF RELATED ART

An electrostatic transducer is one of the basic elements that constitute MEMS. Its basic operating principle is to place opposing electrodes with a gap between the electrodes, apply a bias voltage between the electrodes, and detect a change in the relative distance between the electrodes as a change in electrostatic capacitance. It is also used as an actuator that applies a voltage between two electrodes and drives one or both of the electrodes by electrostatic attraction. Using this electrostatic transducer, minute movements of MEMS can be detected or controlled.

On the other hand, since MEMS are miniscule, the detection limit of electrostatic transducers is dominated by noise. Among various types of noise, there is one whose source is damping caused by gas (air) present in the gap (that is, an electrostatic gap) between the two electrodes. This has become the dominant noise in electrostatic MEMS microphones, for example.

To eliminate noise due to gas damping in the electrostatic gap, the sensor may be vacuum-sealed. This is possible and commonly done, for example, in inertial sensors. However, some devices, such as microphones, ultrasonic sensors, mass sensors, and scanning probes, are difficult to vacuum-seal.

Among these devices, there is a microphone in which an electrostatic capacitance detection portion is placed between two diaphragms, the diaphragms are connected by a pillar, and a closed space between the diaphragms is evacuated (see, for example, Patent Literature 1 or 2). In this microphone, the pillar synchronizes the movement of the two diaphragms and prevents the closed space between the diaphragms from collapsing due to the pressure difference between the atmosphere and the vacuum. This reduces noise due to gas dumping, increases the SN ratio, and achieves a high speech recognition rate as a microphone.

In other microphones, a diaphragm and an electrostatic capacitance detection portion are separated in the plane of the device, the latter is placed in a vacuum space, and the two are connected by a link mechanism (see, for example, Non-Patent Literature 1 or 2). In this microphone, a diaphragm is connected to one end of a link, a detection portion is connected to the other end, and a hinge serving as a support is arranged in the center of the link. In addition, the electrostatic capacitance detection portion is a parallel plate type, and moves like a seesaw by the link mechanism, that is, in the out-of-plane direction.

Some MEMS microphones (acoustic transducers) utilize the piezoelectric effect. For example, as a piezoelectric MEMS microphone, one having a structure in which a plate to which pressure is applied forms four triangular cantilevers with a piezoelectric layer sandwiched between a pair of electrode layers, and these cantilevers are arranged to form a square is known (see, for example, Patent Literatures 3 to 5 or Non-Patent Literature 3). In a piezoelectric MEMS microphone, if the plate to which pressure is applied is formed into a diaphragm shape whose periphery is fixed, the stress of the piezoelectric film degrades performance, so such a configuration is adopted. Piezoelectric transducers do not have an electrode gap and do not generate noise originating from gas damping in the electrode gap. However, since noise is generated due to the dielectric loss of the piezoelectric film, the SN ratio as high as that of the MEMS microphones described in Patent Literature 1 or 2 is not obtained.

### CITATION LIST

### Patent Literature

Patent Literature 1: U.S. Pat. No. 9,181,080
Patent Literature 2: US-A-2016-0066099
Patent Literature 3: JP-B-5936154
Patent Literature 4: U.S. Pat. No. 9,055,372
Patent Literature 5: JP-A-2011-4129

### Non-Patent Literature

Non-Patent Literature 1: Saner Dagher, Carine Ladner, Stephane Durand and Loic Joet, “NOVEL HINGE MECHANISM FOR VACUUM TRANSDUCTION HIGH PERFORMANCE CAPACITIVE MEMS MICROPHONES,” Transducers 2019—-EUROSENSORS XXXIII, Berlin, GERMANY, 23-27 Jun. 2019, p. 663-666
Non-Patent Literature 2: Samer Dagher, Frederic Souchon, Audrey Berthelot, Stephane Durand and Loic Joet, “FIRST IEMS MICROPHONE BASED ON CAPACITIVE TRANSDUCTION IN VACUUM,” IEEE MEMS 2020, Vancouver, CANADA, 18-22 January, 2020, p. 838-841
Non-Patent Literature 3: Robert Littrell and Ronald Gagnon, “PIEZOELECTRIC MEMS MICROPHONE NOISE SOURCES,” Solid-State Sensors, Actuators and Microsystems Workshop, 2016, p. 258-261

### SUMMARY OF THE INVENTION

The MEMS microphones described in Patent Literatures 1 and 2 have a very high SN ratio, but the placement of the detection portion that detects a change in electrostatic capacitance is limited to the space between each of the diaphragms. Thus, there is a problem that the degree of freedom of the structure is small. Therefore, although this structure is effective for microphones and ultrasonic sensors, there is the problem that it cannot be applied to other sensors, for example, mass sensors and scanning probes. Moreover, even when this structure is used as a microphone, the size of the detection portion is limited to the size of the diaphragm or less, which limits the improvement in the sensitivity or the SN ratio.

In the MEMS microphones described in Non-Patent Literatures 1 and 2, the size of the diaphragm and the size of the electrostatic capacitance detection portion are independent, and these sizes can be freely designed according to desired specifications. However, since the link that transmits the movement of the diaphragm to the detection portion is connected from the atmosphere to the vacuum through the membrane at the hinge, the movement of the link is hindered by the membrane, resulting in a reduction in the SN ratio. If the membrane is made thinner or larger, the rigidity of the membrane will decrease, and in principle the link will move more easily. However, the membrane is distorted by the pressure difference between the atmosphere and the vacuum, and this causes an error in the sensor. In addition, the stress of the distorted membrane eventually makes the link difficult to move, resulting in a decrease in the SN ratio.

The present invention has been made in view of such problems, and an object thereof is to provide an electrostatic transducer that can be applied to various sensors, can obtain a high SN ratio, and can increase the degree of freedom in the arrangement and structure of the portion that detects a change in electrostatic capacitance and to provide a method of manufacturing the electrostatic transducer.

In order to achieve the above object, an electrostatic transducer according to the present invention includes a support, a displacement plate having a fixed portion fixed to the support and a fluctuating portion provided to freely fluctuate with respect to the fixed portion, and a detection means, at least a portion of which is attached so as to freely fluctuate together with the fluctuating portion, and provided so as to be able to detect the fluctuation of the fluctuating portion as a change in electrostatic capacitance, wherein the detection means is arranged in a vacuum or low-pressure space.

The electrostatic transducer according to the invention is preferably a MEMS device. In the electrostatic transducer according to the present invention, the detection means provided so as to be able to detect the fluctuation of the fluctuating portion of the displacement plate as a change in electrostatic capacitance is arranged in the vacuum or low-pressure space. Thus, the electrostatic transducer is less susceptible to damping and the like caused by surrounding fluids such as liquids or gases such as air. Therefore, noise can be reduced and a high SN ratio can be obtained.

Further, it is sufficient that at least a portion of the detection means is attached so as to freely fluctuate together with the fluctuating portion in order to detect the fluctuation of the fluctuating portion. The other portion (hereinafter referred to as a “fluctuation detection portion”) of the detection means may be disposed in the fluctuating portion and may be disposed in a stable place other than the fluctuating portion. Further, by arranging the fluctuation detection portion at a position that does not interfere with the fluctuation of the fluctuating portion, the structure of the fluctuation detection portion can be configured relatively freely. In this way, the electrostatic transducer according to the present invention can increase the degree of freedom in the arrangement and structure of the detection means for detecting a change in electrostatic capacitance.

In the electrostatic transducer according to the present invention, since the fluctuation detection portion can be disposed in a place other than the fluctuating portion and the fluctuating portion and the fluctuation detection portion can be separated, they can be designed independently according to the required performance, and the degree of freedom in design is high. For example, the fluctuating portion can be made smaller to increase resistance to excessive pressure input and mechanical impact, and the size of the fluctuation detection portion can be increased to achieve a structure that increases sensitivity. In this case, since the fluctuation detection portion is arranged in the vacuum or low-pressure space, it is possible to suppress an increase in noise even if the sensitivity of the fluctuation detection portion is increased.

In addition, in the electrostatic transducer according to the present invention, since the detection means is arranged in the vacuum or low-pressure space, a structure such as a membrane that separates the atmosphere and the vacuum or reduced-pressure space is not necessary in the middle of the detection means unlike Non-Patent Literatures 1 and 2. Such a structure does not hinder the movement of the detection means. In addition, in Non-Patent Literatures 1 and 2, the portion that detects the electrostatic capacitance is a parallel plate type that moves in the out-of-plane direction. However, the electrostatic transducer according to the present invention can be designed in a structure in which the portion that detects the electrostatic capacitance moves in either the in-plane direction or the out-of-plane direction, or a structure in which the portion moves in both the in-plane direction and the out-of-plane direction.

In the electrostatic transducer according to the present invention, as an example of a configuration in which the fluctuation detection portion is arranged in a place other than the fluctuating portion, the detection means may include an elongated connecting portion, one end of which is fixed to the fluctuating portion and the other end of which extends toward the fixed portion, and a fluctuation detection portion connected to the other end of the connecting portion and provided so as to be able to detect fluctuation of the other end as fluctuation of the fluctuating portion. In this case, the connecting portion can expand the fluctuation of the fluctuating portion and transmit it to the fluctuation detection portion. The fluctuation detection portion may be provided anywhere other than the fluctuating portion, for example, it may be provided on the fixed portion or the support.

In the electrostatic transducer according to the present invention, the fluctuation detection portion may have any configuration as long as it can detect the fluctuation of the fluctuating portion as a change in electrostatic capacitance. For example, a configuration in which the interval or overlap between electrodes for detecting electrostatic capacitance is changed according to the fluctuation of the fluctuating portion may be employed, or a differential configuration may be employed.

In the electrostatic transducer according to the present invention, the fluctuating portion may have a reinforcing portion provided to be uniaxially bent and displaced in a thickness direction of the displacement plate. In this case, the uniaxial bending displacement in the thickness direction of the displacement plate can be detected with high accuracy. In addition, it is possible to prevent the displacement plate from fluctuating in a direction other than the desired direction, twisting and breaking.

In the electrostatic transducer according to the present invention, the displacement plate may be provided in a cantilever shape, have the fixed portion on one end side, and have the fluctuating portion on the other end side. Further, the displacement plate may be provided in a double-supported beam shape, and the fixed portion may be provided so as to sandwich the fluctuating portion. Further, the displacement plate may be provided in a diaphragm shape, have the fixed portion on a peripheral edge, and have the fluctuating portion inside the peripheral edge.

In the electrostatic transducer according to the present invention, when the displacement plate is provided in the cantilever shape, the support may have an opening in the center, and the displacement plate may be provided so that the fluctuating portion protrudes toward the opening and covers or substantially covers the opening. Alternatively, the electrostatic transducer may be composed of a plurality of electrostatic transducers, which may be arranged so that each fluctuating portion is on an inner side, the periphery of each fluctuating portion is surrounded by each support, and each fluctuating portion covers or substantially covers a space surrounded by the supports. In these cases, the electrostatic transducer can be used, for example, as a microphone, virtually like a diaphragm. In addition, in order to prevent a fluid such as air from leaking in and lowering the sensitivity when the fluctuating portion fluctuates, it is preferable that the gap between the fluctuating portion and the support or the gap between the fluctuating portions of the adjacent fluctuating portions is 10 μm or less.

The electrostatic transducers according to the present invention can be used as various sensors, for example, such as acoustic transducers such as microphones and ultrasonic sensors, mass sensors, mass-detection or frequency-detection chemical sensors, displacement sensors, displacement-detection chemical sensors, flow sensors, and scanning probes. Moreover, since the detection means is arranged in the vacuum or low-pressure space, the electrostatic transducer can be used not only in gas but also in liquid. The electrostatic transducer according to the present invention can also be used as an actuator instead of a sensor to drive a displacement plate and to emit sound waves.

A method of manufacturing the electrostatic transducer according to the present invention includes: for a laminate obtained by laminating a first layer, a second layer, and a third layer in this order on a surface of a base layer, processing the third layer from a surface side opposite to the second layer to form a structure of the detection means and form one or a plurality of first through-holes penetrating to the second layer; forming a fourth layer and a fifth layer in this order on the processed surface of the third layer opposite to the second layer; forming, in the fifth layer, one or a plurality of second through-holes penetrating to the fourth layer from a surface side of the fifth layer opposite to the fourth layer; removing a portion of the fourth layer and a portion of the second layer through the second through-hole formed in the fifth layer and the first through-hole formed in the third layer, and then closing the second through-hole formed in the fifth layer so that the third layer constitutes the detection means and the detection means is disposed in a vacuum or low-pressure space; and removing the base layer corresponding to the position of the fluctuating portion so that the first layer constitutes a displacement plate.

The electrostatic transducer manufacturing method according to the present invention can suitably manufacture the electrostatic transducer according to the present invention. In the method of manufacturing the electrostatic transducer according to the present invention, the electrostatic transducer may be manufactured while forming the first to fifth layers, respectively, and the electrostatic transducer may be manufactured using a commercially available double SOI wafer or SOI wafer. Further, when laminating the first to fifth layers, the lamination step of at least one of the layers may be performed by wafer bonding. Further, in the method of manufacturing the electrostatic transducer according to the present invention, for example, the first, third and fifth layers may be made of silicon (Si), and the second and fourth layers may be made of silicon oxide (SiO₂).

In the method of manufacturing the electrostatic transducer according to the present invention, it is preferable that the fifth layer is made of silicon, and the second through-hole formed in the fifth layer is closed by silicon surface migration. In this case, the second through-hole can be easily closed only by heat treatment. Further, the fifth layer is preferably made of monocrystalline silicon. As a result, a high-quality electrostatic transducer can be manufactured without a change in mechanical properties or the like even when heat treatment for surface migration is performed.

Further, in the method of manufacturing the electrostatic transducer according to the present invention, the second through-hole formed in the fifth layer may be closed by forming a film of silicon, silicon oxide, silicon nitride (SiₓN_{y}), metal, or the like. Further, after a film of silicon is formed on the second through-hole, the second through-hole may be closed by silicon surface migration by performing heat treatment.

In the method of manufacturing the electrostatic transducer according to the present invention, annealing may be performed in an environment with a low hydrogen partial pressure such as a nitrogen atmosphere after closing the second through-hole. In this case, the hydrogen in the space where the detection means is arranged can be discharged by diffusion, and the degree of vacuum can be increased.

According to the present invention, it is possible to provide an electrostatic transducer that can be applied to various sensors, can obtain a high SN ratio, and can increase the degree of freedom in the arrangement and structure of the portion that detects a change in electrostatic capacitance and to provide a method of manufacturing the electrostatic transducer.

### BRIEF DESCRIPTION OF THE DRAWINGS

FIG. 1(a) is a plan view showing an electrostatic transducer according to an embodiment of the present invention and FIG. 1(b) is a cross-sectional view taken along line A-A′.

FIG. 2 is a plan view of the electrostatic transducer shown in FIG. 1 with the sealing cover removed.

FIGS. 3(a) to 3(d) are cross-sectional views showing a method of manufacturing the electrostatic transducer according to the embodiment of the present invention.

FIGS. 4(a) to 4(f) are cross-sectional views showing the continuation of FIG. 3, of the method of manufacturing the electrostatic transducer according to the embodiment of the present invention.

FIG. 5 is a plan view showing a modification example of the electrostatic transducer shown in FIG. 1, in which a plurality of fluctuating portions are arranged in a diaphragm shape.

FIG. 6(a) is a cross-sectional view of a state where a fluctuating portion does not fluctuate and FIG. 6(b) is a cross-sectional view of a state where the fluctuating portion fluctuates, showing a modification example of the electrostatic transducer according to the embodiment of the present invention, in which the fluctuation detection portion moves along a thickness direction of a displacement plate.

FIG. 7(a) is a plan view showing a modification example of the electrostatic transducer according to the embodiment of the present invention, in which the fluctuation detection portion is provided in the fluctuating portion and FIG. 7(b) is a cross-sectional view taken along line B-B′.

FIG. 8 is a plan view of the electrostatic transducer shown in FIG. 7 with the sealing cover removed.

### DETAILED DESCRIPTION OF THE INVENTION

Hereinafter, an embodiment of the present invention will be described with reference to the drawings.

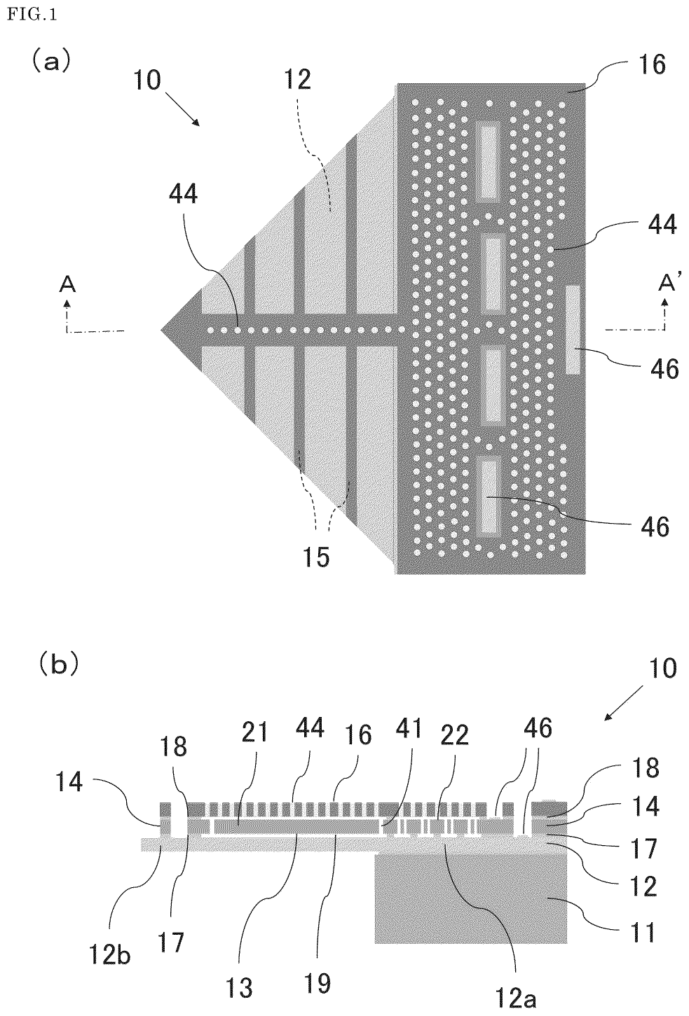

FIGS. 1 to 8 show an electrostatic transducer and a method of manufacturing the electrostatic transducer according to an embodiment of the present invention.

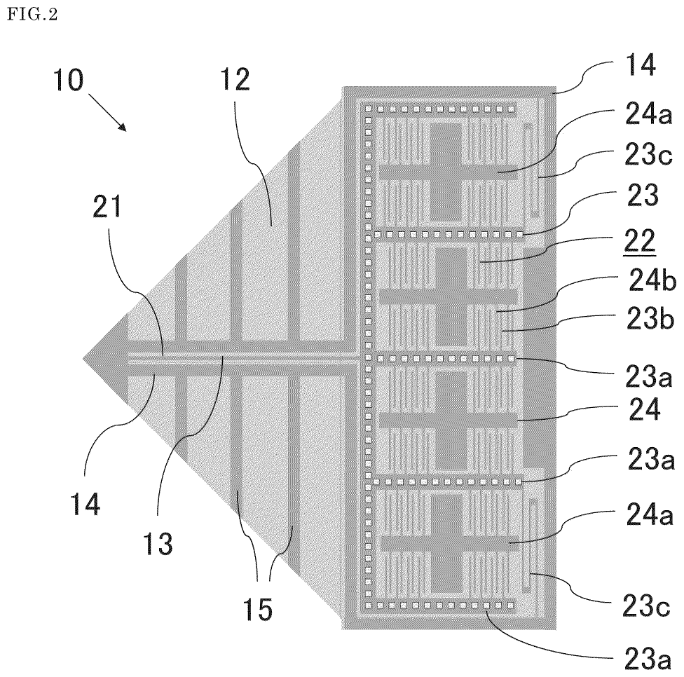

As shown in FIGS. 1 and 2, an electrostatic transducer 10 is composed of a MEMS device, and includes a support 11, a displacement plate 12, a detection means 13, a sealing frame 14, a reinforcing portion 15, and a sealing cover 16.

The support 11 has a rectangular plate shape having a predetermined thickness.

The displacement plate 12 has a thin plate shape, has a fixed portion 12a having a rectangular planar shape on one end side, and has a triangular fluctuating portion 12b on the other end side with one long side of the fixed portion 12a as the base. The displacement plate 12 is fixed by bonding one surface of the fixed portion 12a to one surface of the support 11 so that the fluctuating portion 12b protrudes from the support 11. As a result, the displacement plate 12 has a cantilever shape in which the fluctuating portion 12b provided by extending the fixed portion 12a can fluctuate in relation to the fixed portion 12a.

The detection means 13 is provided along the surface of the displacement plate 12 on the side opposite to the support 11 with a gap therebetween. The detection means 13 has an elongated connecting portion 21 and a fluctuation detection portion 22. One end of the connecting portion 21 is arranged at the vertex of the triangular fluctuating portion 12b, and the other end extends to the fixed portion 12a at the center of the base of the fluctuating portion 12b The fluctuation detection portion 22 includes first comb-shaped electrodes 23 arranged on the fixed portion 12a and connected to the other end of the connecting portion 21, and second comb-shaped electrodes 24 provided to mesh with the first comb-shaped electrodes 23. The second comb-shaped electrodes 24 are arranged in a row and two pairs are arranged symmetrically each of the left and right sides of the extension line of the connecting portion 21. The first comb-shaped electrodes 23 are arranged in a row and are provided on the left and right sides of each of the second comb-shaped electrodes 24, and a total of five electrodes are arranged symmetrically with respect to the extension line of the connecting portion 21.

Each of the first comb-shaped electrodes 23 includes a supporting portion 23a extending in parallel to the length direction of the connecting portion 21, and a number of teeth 23b arranged so as to extend in a direction perpendicular to the length direction of the connecting portion 21 from the left and right sides of the supporting portion 23a (the three electrodes in the middle among the first comb-shaped electrodes 23) or one of the left and right sides (the two electrodes at both ends among the first comb-shaped electrode 23). The first comb-shaped electrodes 23, which are the second and fourth electrodes among the first comb-shaped electrodes 23, have spring-shaped connecting portions extending in a spring shape from the end of the supporting portion 23a on the side opposite to the connecting portion 21. Each second comb-shaped electrode 24 includes a supporting portion 24a extending in parallel to the length direction of the connecting portion 21 and a number of teeth 24b arranged so as to extend in a direction perpendicular to the length direction of the connecting portion 21 from the left and right sides of the supporting portion 24a. The fluctuation detection portion 22 is configured so that the tooth 23b of the first comb-shaped electrode 23 and the tooth 24b of the second comb-shaped electrode 24 that are adjacent to each other mesh with each other, and is configured to detect a change in the interval between the adjacent teeth as a change in electrostatic capacitance.

The sealing frame 14 is provided along the surface of the displacement plate 12 opposite to the support 11 and in contact with the surface. The sealing frame 14 is provided with a gap between the connecting portion 21 and the fluctuation detection portion 22 so as to surround both sides of the connecting portion 21 and the periphery of the fluctuation detection portion 22. Further, the sealing frame 14 is connected to one end of the connecting portion 21. The sealing frame 14 is connected to the spring-shaped connecting portions 23c near two corners of the fixed portion 12a on the side opposite to the fluctuating portion 12b in the portion surrounding the periphery of the fluctuation detection portion 22.

The reinforcing portion 15 is composed of a plurality of reinforcing portions which are provided so as to extend in a direction perpendicular to the length direction of the connecting portion 21 at predetermined intervals along the length direction of the connecting portion 21 toward the outer side from the sealing frames 14 provided on both sides of the connecting portion 21.

One end of the connecting portion 21 of the detection means 13 is fixed to the fluctuating portion 12b of the displacement plate 12 via a first spacer 17. In addition, the supporting portion 24a of the second comb-shaped electrode 24 of the detection means 13 is fixed to the fixed portion 12a of the displacement plate 12 via the first spacer 17. The sealing frame 14 and the reinforcing portion 15 are fixed to the displacement plate 12 via the first spacer 17. In this way, the electrostatic transducer 10 is configured such that the fluctuating portion 12b is uniaxially bent and displaced in the thickness direction of the displacement plate 12 by the reinforcing portion 15.

In the electrostatic transducer 10, one end of the connecting portion 21 fluctuates together with the fluctuating portion 12b, whereby the connecting portion 21 is bent and the other end of the connecting portion 21 is pulled along its length direction. In addition, as a result, the interval between the tooth 23b of the first comb-shaped electrode 23 and the tooth 24b of the second comb-shaped electrode 24, which are adjacent to each other, changes, so that the electrostatic capacitance changes. In this way, the electrostatic transducer 10 can detect the fluctuation of the fluctuating portion 12b as a change in electrostatic capacitance. In the specific example shown in FIGS. 1 and 2, the fluctuation detection portion 22 is configured such that when the connecting portion 21 is bent and pulled, the interval between the tooth 24b of one second comb-shaped electrode 24 on each of the left and right sides of the extension line of the connecting portion 21 and the tooth 23b of the first comb-shaped electrode 23 adjacent thereto (the interval between the teeth for detecting the electrostatic capacitance) is widened, and the interval in the other two second comb-shaped electrodes is narrowed. In this way, the electrostatic transducer 10 is configured to perform differential detection.

The sealing cover 16 has a thin plate shape that covers the detection means 13, and is disposed with a gap between the sealing cover 16 and the detection means 13 so that the detection means 13 and the sealing frame 14 are sandwiched between the sealing cover 16 and the displacement plate 12. The sealing cover 16 is fixed to one end of the connecting portion 21, the supporting portion 24a of the second comb-shaped electrode 24, and the sealing frame 14 via a second spacer 18. A portion of the reinforcing portion 15 is configured by a thin plate that constitutes the sealing cover 16. At this portion, the thin plate forming the sealing cover 16 is fixed to the displacement plate 12 via the second spacer 18.

In the electrostatic transducer 10, the detection means 13 is hermetically sealed by the displacement plate 12, the first spacer 17, the sealing frame 14, the second spacer 18 and the sealing cover 16 with a gap. In the electrostatic transducer 10, the space 19 around the detection means 13 is in the vacuum or low-pressure state, and the detection means 13 is arranged in the vacuum or low-pressure space 19.

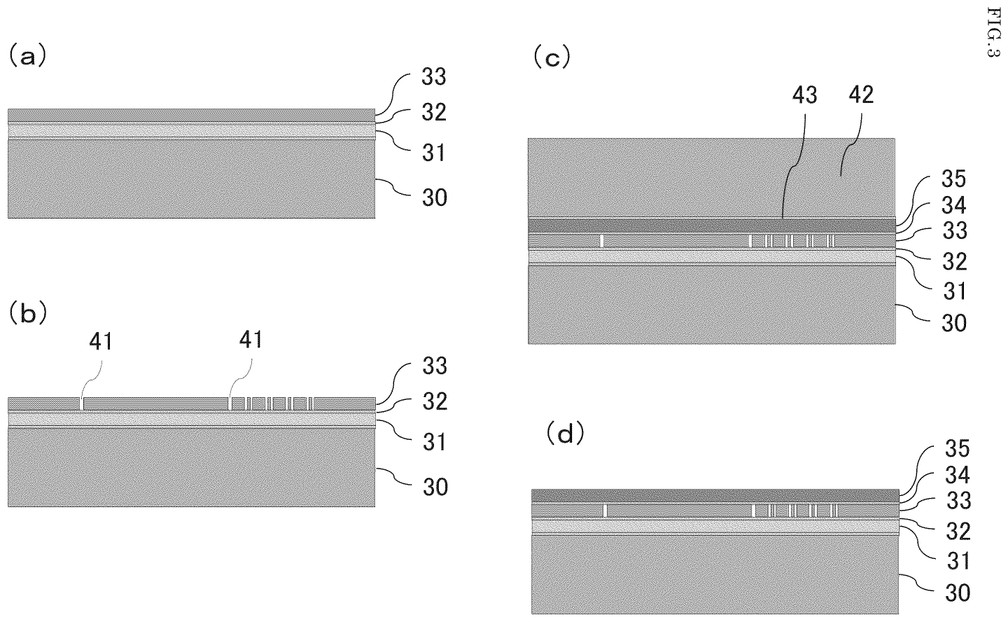

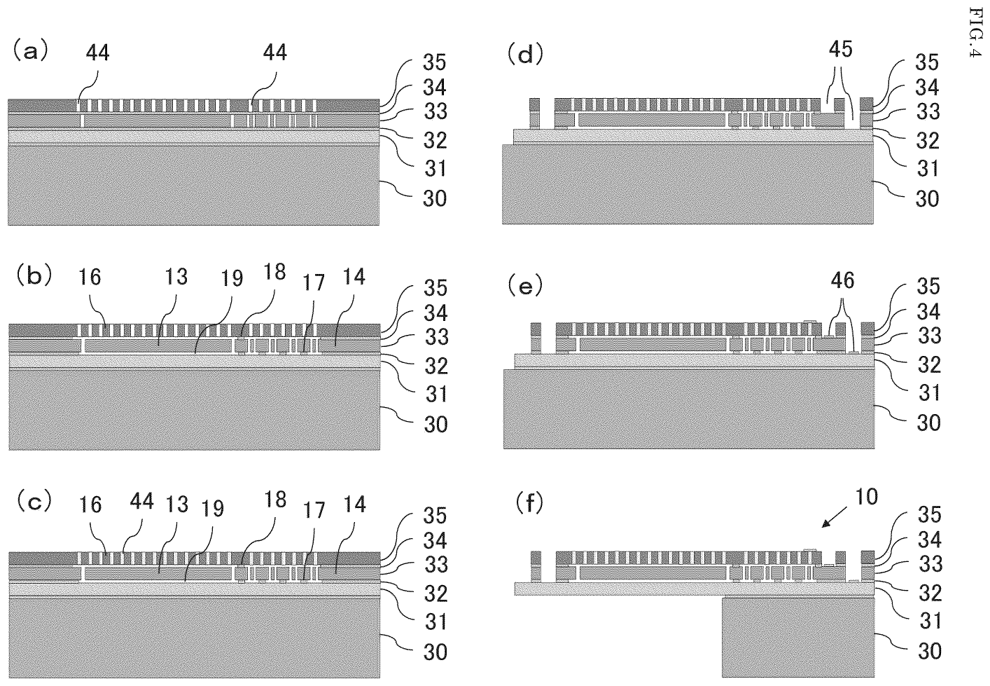

The electrostatic transducer 10 can be suitably manufactured by a method of manufacturing the electrostatic transducer according to the embodiment of the present invention. That is, as shown in FIGS. 3 and 4, in the method of manufacturing the electrostatic transducer according to the embodiment of the present invention, first, a laminate in which a first layer 31, a second layer 32, and a third layer 33 are formed in this order on the surface of the base layer 30 is prepared (see FIG. 3(a)). In addition, in the specific example shown in FIG. 3(a), a double SOI wafer is used as the laminate, but the laminate may be formed by deposition. The base layer 30 is a Si layer and a SiO₂ layer, the first layer 31 is a Si layer (0.5 μm thick), the second layer 32 is a SiO₂ layer (0.1 μm thick), and the third layer 33 is a Si layer (0.5 μm thick).

Next, the third layer 33 is patterned from the surface opposite to the second layer 32 to form the structure of the detection means 13, the sealing frame 14 and the reinforcing portion 15, and form one or a plurality of first through-holes 41 penetrating to the second layer 32 (see FIG. 3(b) and FIG. 1). Next, a fourth layer 34 and a fifth layer 35 are formed in this order on the processed surface of the third layer 33 opposite to the second layer 32 (see FIGS. 3(c) and 3(d)). In a specific example shown in FIGS. 3(c) and 3(d), an SOI wafer is substrate-bonded to the surface of the third layer 33 (see FIG. 3(c)), and a handle layer 42 of the SOT wafer and a BOX layer 43 are removed to form the fourth layer 34 and the fifth layer 35 (see FIG. 3(d)). However, each layer may be formed by deposition. The fourth layer 34 corresponds to a SiO₂ layer (0.1 μm thick), and the fifth layer 35 corresponds to a Si layer (0.5 μm thick).

Next, one or a plurality of second through-holes 44 penetrating to the fourth layer 34 are formed in the fifth layer 35 from the surface opposite to the fourth layer 34 (see FIG. 4(a) and FIG. 1). Next, portions of the fourth layer 34 and the second layer 32 are removed by etching through the second through-hole 44 formed in the fifth layer 35 and the first through-hole 41 formed in the third layer 33 so that the third layer 33 constitutes the detection means 13, the sealing frame 14 and the reinforcing portion 15, the detection means 13 is placed in the vacuum or low-pressure space 19, and the second layer 32 constitutes the first spacer 17, the fourth layer 34 constitutes the second spacer 18, and the fifth layer 35 constitutes the sealing cover 16 (see FIG. 4(b)). After that, the second through-hole 44 formed in the fifth layer 35 is closed (see FIG. 4(c)). In the specific example shown in FIG. 4(c), since the fifth layer 35 is made of silicon, the second through-hole 44 is closed by the surface migration of the silicon in the fifth layer 35 due to heat treatment in hydrogen by a so-called silicon migration seal (SMS). Further, after that, by performing heat treatment in an atmosphere with a sufficiently low hydrogen concentration, hydrogen gas is discharged from the space 19 where the detection means 13 is arranged by thermal diffusion phenomenon, and the space 19 is brought into a vacuum or low-pressure state.

Next, the second to fifth layers 32 to 35 are shaped from the side of the fifth layer 35 so that the structure of the displacement plate 12 is formed on the first layer 31, and the holes 45 for the terminals of the first comb-shaped electrode 23 and the second comb-shaped electrode 24 of the fluctuation detection portion 22 of the third layer 33 are formed (see FIG. 4(d)). Moreover, metal terminals 46 electrically connected to the teeth of the first comb-shaped electrode 23 and the teeth of the second comb-shaped electrode 24 are formed in the formed terminal holes 45 (see FIG. 4(e)). Next, deep etching (DRIE) is performed to remove the base layer 30 corresponding to the position of the fluctuating portion 12b so that the first layer 31 constitutes the displacement plate 12 (see FIG. 4(f)). Note that the base layer 30 constitutes the support 11. In this way, the electrostatic transducer 10 can be manufactured.

In the electrostatic transducer 10, the detection means 13 provided so as to be able to detect the fluctuation of the fluctuating portion 12b of the displacement plate 12 as a change in electrostatic capacitance is arranged in the vacuum or low-pressure space 19. Thus, the electrostatic transducer 10 is less susceptible to damping and the like caused by surrounding fluids such as liquids or gases such as air. Therefore, noise can be reduced and a high SN ratio can be obtained.

In addition, the electrostatic transducer 10 has the fluctuation detection portion 22 arranged on the fixed portion 12a fixed to the support 11, and is stable without interfering with the fluctuation of the fluctuating portion 12b. Due to this, the structure of the fluctuation detection portion 22 can be configured relatively freely, and the degree of freedom in the arrangement and structure of the detection means 13 for detecting a change in electrostatic capacitance can be increased. In addition, since the fluctuating portion 12b and the fluctuation detection portion 22 can be separated, they can be designed independently according to the required performance, and the degree of freedom in design is high. For example, the fluctuating portion 12b can be made smaller to increase resistance to excessive pressure input and mechanical impact, and the number of teeth of the first comb-shaped electrode 23 and the second comb-shaped electrode 24 of the fluctuation detection portion 22 can be increased to achieve a structure that increases sensitivity. In this case, since the fluctuation detection portion 22 is arranged in the vacuum or low-pressure space 19, it is possible to suppress an increase in noise even if the sensitivity of the fluctuation detection portion 22 is increased.

Further, since the electrostatic transducer 10 has the fluctuation detection portion 22 arranged at a position different from that of the fluctuating portion 12b, it is possible to prevent the fluctuating portion 12b from becoming hard. Further, the portion that fluctuates together with the fluctuating portion 12b can be lightened, and the resonance frequency of the fluctuating portion 12b can be increased. In the electrostatic transducer 10, since the reinforcing portion 15 can suppress the bending of the fluctuating portion 12b in directions other than the length direction of the displacement plate 12, the uniaxial bending displacement of the displacement plate 12 can be detected with high accuracy. In addition, it is possible to prevent the displacement plate 12 from fluctuating in a direction other than the desired direction, twisting and breaking.

Further, in the electrostatic transducer 10, the second through-hole 44 can be easily closed only by heat treatment due to the silicon surface migration of the fifth layer 35, and the detection means 13 can be arranged in the vacuum or low-pressure space 19. In this case, by forming the fifth layer 35 from single-crystal silicon, a high-quality electrostatic transducer can be manufactured without a change in mechanical properties or the like even when heat treatment for surface migration is performed. Note that the planar shape of the fluctuating portion 12b of the electrostatic transducer 10 is not limited to a triangular shape, and may be any shape such as a rectangular shape or an elongated rod shape.

Further, in the electrostatic transducer 10, since the detection means 13 is arranged in the vacuum or low-pressure space 19, a structure such as a membrane that separates the atmosphere and the vacuum or reduced-pressure space is not necessary in the middle of the detection means unlike Non-Patent Literatures 1 and 2, Such a structure does not hinder the movement of the detection means 13.

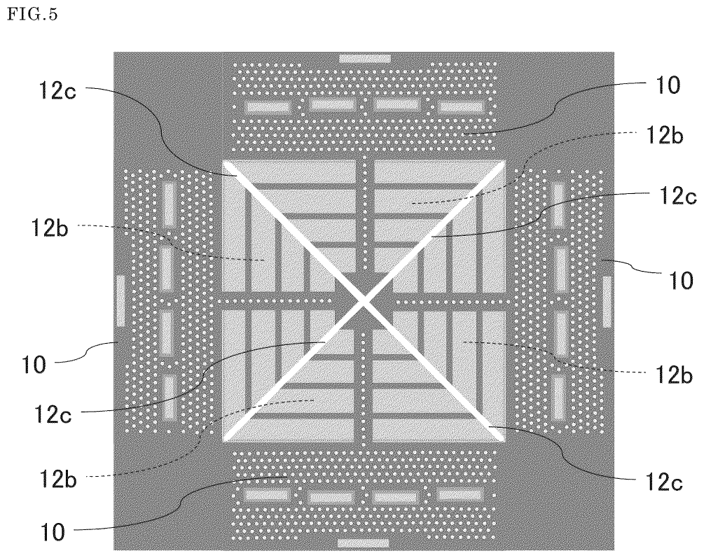

As shown in FIG. 5, the electrostatic transducer 10 may be composed of four electrostatic transducers which are arranged so that each fluctuating portion 12b is on the inner side, the periphery of each fluctuating portion 12b is surrounded by each support 11, and the vertices of the triangular fluctuating portions 12b are concentrated at the center of the space surrounded by the supports 11, and the fluctuating portions 12b substantially cover the space surrounded by the supports 11. In a specific example shown in FIG. 5, the vertex angle of each triangular fluctuating portion 12b is 90°, and the fluctuating portions 12b are arranged with a slight gap 12c between the sides of adjacent, fluctuating portions 12b. In this case, the electrostatic transducer can be used, for example, as a microphone, virtually like a diaphragm. Further, in order to prevent a fluid such as air from leaking in and lowering the sensitivity when the fluctuating portion 12b fluctuates, it is preferable that the gap 12c between the sides of the adjacent fluctuating portions 12b is 10 μm or less, and the gap 12c may be eliminated so that the space 19 surrounded by the supports 11 is completely covered. Further, the number of electrostatic transducers 10 is not limited to four, and may be any number as long as it is plural. Further, the planar shape of the fluctuating portion 12b is not limited to a triangular shape, and may be any shape as long as it can completely cover or substantially cover the space 19 surrounded by the supports 11.

Further, the electrostatic transducer 10 may be composed of one electrostatic transducer, the support 11 may have an opening in the center, and the displacement plate 12 may be provided so that the fluctuating portion 12b protrudes toward the opening and covers or substantially covers the opening. In this case, the electrostatic transducer can be used, for example, as a microphone, virtually like a diaphragm. Further, in order to prevent a fluid such as air from leaking in and lowering the sensitivity when the fluctuating portion 12b fluctuates, the gap between the fluctuating portion 12b and the support 11 is preferably 10 μm or less, and the gap may be eliminated so that the opening of the support 11 is completely covered. Further, the planar shape of the fluctuating portion 12b may be any shape according to the shape of the opening of the support 11. It should be noted that the displacement plate 12 may be provided in a double-supported beam shape so as to cover the opening of the support 11, and the fixed portions 12a may be provided so as to sandwich the fluctuating portion 12b. Further, the displacement plate 12 may be provided in a diaphragm shape so as to cover the opening of the support 11, have the fixed portion 12a on the peripheral edge, and have the fluctuating portion 12b on the inner side of the peripheral edge.

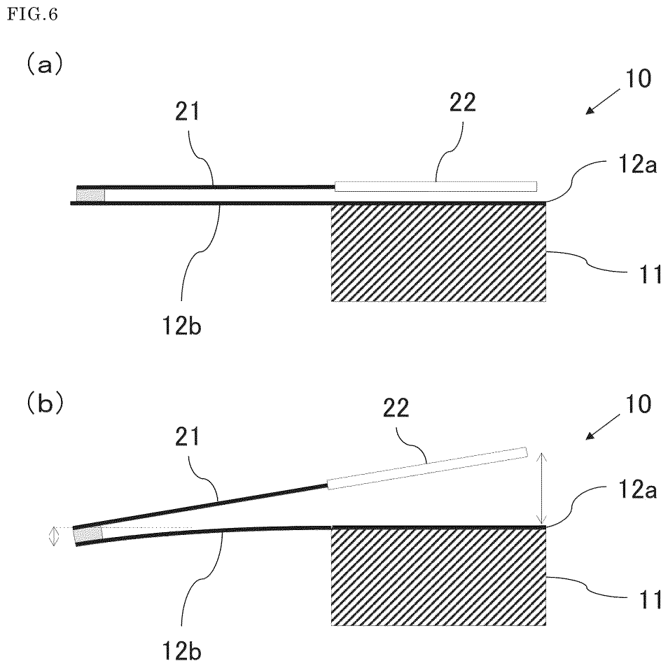

In the electrostatic transducer 10, the first comb-shaped electrodes 23 and the second comb-shaped electrodes 24 are not limited to the arrangement shown in FIGS. 1 and 2, and may be arranged in any form. The electrostatic transducer 10 shown in FIGS. 1 and 2 is configured so that when the fluctuating portion 12b fluctuates, the connecting portion 21 is bent together with the fluctuating portion 12b, and the first comb-shaped electrode 23 of the fluctuation detection portion 22 moves in the in-plane direction along the surface bent of the fluctuating portion 12b. However, as shown in FIG. 6, the electrostatic transducer 10 may be configured so that when the fluctuating portion 12b fluctuates, the connecting portion 21 is not bent, and the fluctuation detection portion 22 connected to the other end of the connecting portion 21 is movable in the out-of-plane direction along the thickness direction of the displacement plate 12. In this case, the electrostatic transducer 10 may be configured so that the fluctuation of the fluctuating portion 12b is detected as a change in the overlap of the first comb-shaped electrode 23 and the second comb-shaped electrode 24 in the thickness direction. Alternatively, the electrostatic transducer 10 may be configured so that the fluctuation is detected as a change in electrostatic capacitance due to a change in the interval between the fluctuation detection portion 22 and the fixed portion 12a.

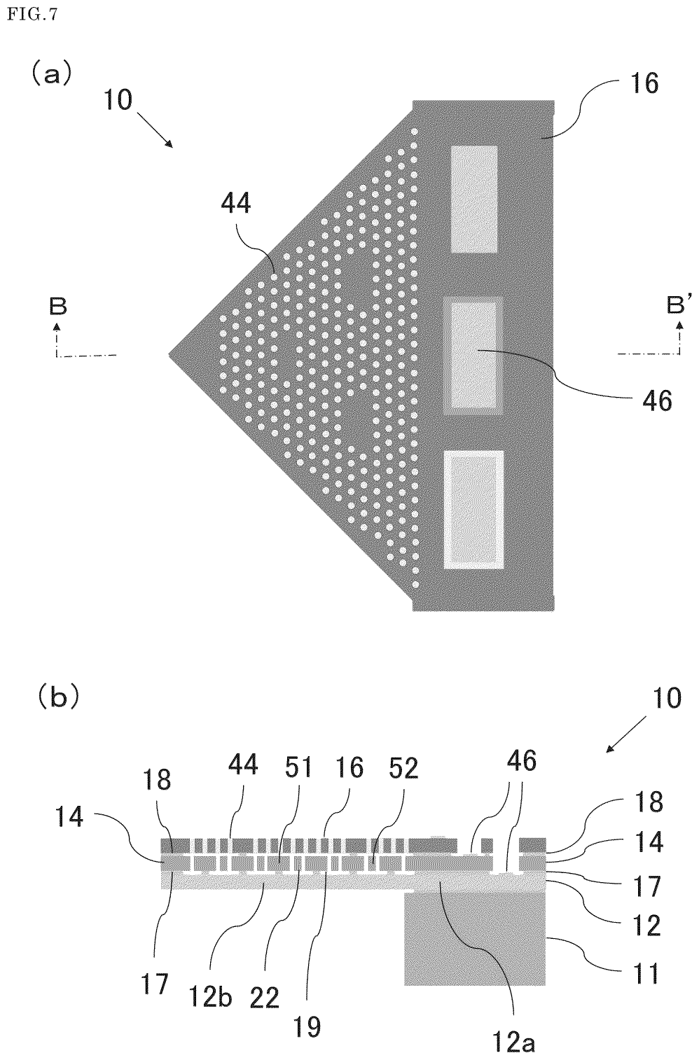

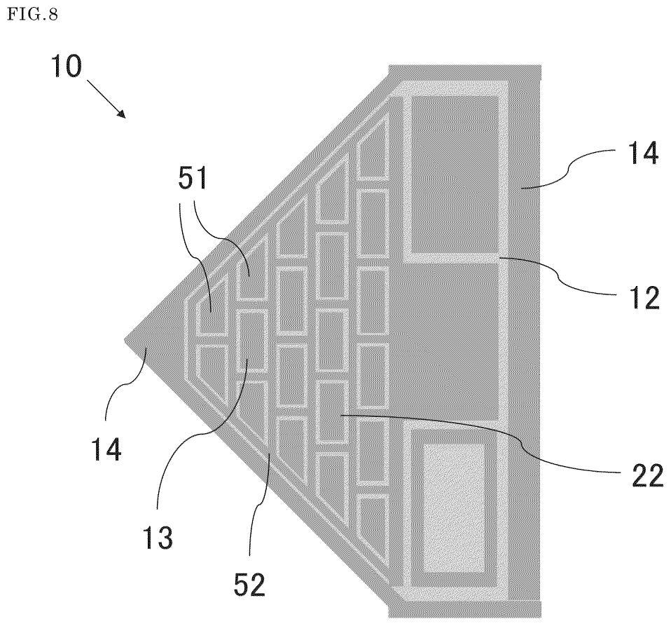

As shown in FIGS. 7 and 8, the electrostatic transducer 10 may not have the connecting portion 21, and the fluctuation detection portion 22 of the detection means 13 may include a plurality of fixed electrodes 51 arranged along the surface of the fluctuating portion 12b and fixed to the fluctuating portion 12b, and mesh electrodes 52 disposed at intervals between the fixed electrodes 51 so as to surround the periphery of each fixed electrode 51 along the surface of the fluctuating portion 12b. The sealing frame 14 may be provided so as to surround the fixed electrodes 51 and the mesh electrodes 52 along the peripheral edge of the fluctuating portion 12b. In this case, the fluctuation detection portion 22 is provided in the fluctuating portion 12b. However, the fluctuation of the fluctuating portion 12b changes the interval between the fixed electrode 51 and the mesh electrode 52, which changes the electrostatic capacitance. Thus, the fluctuation of the fluctuating portion 12b can be detected as a change in electrostatic capacitance.

In the method of manufacturing the electrostatic transducer according to the embodiment of the present invention shown in FIGS. 3 and 4, after forming up to the third layer 33, only the third layer 33 is subjected to patterning and the like (see FIG. 3(b)). Further, after forming up to the fifth layer 35, the second through-hole 44 is formed in the fifth layer 35 (see FIG. 4(a)), and the fourth layer 34 and the second layer 32 are etched (see FIG. 4(b)). However, each layer may be patterned every time the layers from the second layer 32 to the fifth layer 35 are formed, and after the second through-hole 44 is formed in the fifth layer 35, the fourth layer 34 and the second layer 32 may be further etched.

Furthermore, in the method shown in FIGS. 3 and 4, after the first layer 31, the second layer 32 and the third layer 33 are formed on the base layer 30 (see FIG. 3(a)), etching and the like are performed. However, the connecting portion 21, the second comb-shaped electrode 24, the spring-shaped connecting portion 23c, and the displacement plate 12 may be connected using the material of the third layer 33 as the first spacer 17. In this case, the third layer 33 may be formed after the second layer 32 is partially etched. The same applies to the fourth and fifth layers, and the connecting portion 21, the second comb-shaped electrode 24, the spring-shaped connecting portion 23c, and the sealing cover 16 may be connected using the material of the fifth layer 35 as the second spacer 18. In this case, the fifth layer 35 may be deposited after the fourth layer 34 is partially etched. The sacrificial layer etching of FIG. 4(b) is controlled so as to leave the first spacers 17 and the second spacers 18, which is facilitated by this method.

### REFERENCE SIGNS LIST

10: Electrostatic transducer
11: Support
12: Displacement plate
12a: Fixed portion
12b: Fluctuating portion
13: Detection means
21: Connecting portion
22: Fluctuation detection portion
23: First comb-shaped electrode
23a: Supporting portion
23b: Tooth
23c: Spring-shaped connecting portion
24: Second comb-shaped electrode
24a: Supporting portion
24b: Tooth
14: Sealing frame
15: Reinforcing portion
16: Sealing cover
17: First spacer
18: Second spacer
19: Space
30: Base layer
31: First layer
32: Second layer
33: Third layer
34: Fourth layer
35: Fifth layer
41: First through-hole
42: Handle layer
43: BOX layer
44: Second through-hole
45: Hole
46: Metal terminal
51: Fixed electrode
52: Mesh electrode

1. An electrostatic transducer comprising:
a support;
a displacement plate having a fixed portion fixed to the support and a fluctuating portion provided to freely fluctuate with respect to the fixed portion; and
a detection means, at least a portion of which is attached so as to freely fluctuate together with the fluctuating portion, and provided so as to be able to detect the fluctuation of the fluctuating portion as a change in electrostatic capacitance, wherein
the detection means is arranged in a vacuum or low-pressure space.

2. The electrostatic transducer according to claim 1, wherein
the detection means includes an elongated connecting portion, one end of which is fixed to the fluctuating portion and the other end of which extends toward the fixed portion, and a fluctuation detection portion connected to the other end of the connecting portion and provided so as to be able to detect fluctuation of the other end as fluctuation of the fluctuating portion.

3. The electrostatic transducer according to claim 2, wherein
the fluctuation detection portion is provided on the fixed portion or the support.

4. The electrostatic transducer according to claim 1, wherein
the detection means is attached to the fluctuating portion.

5. The electrostatic transducer according to claim 1, wherein
the fluctuating portion has a reinforcing portion provided to be uniaxially bent and displaced in a thickness direction of the displacement plate.

6. The electrostatic transducer according to claim 1, wherein
the displacement plate is provided in a cantilever shape, has the fixed portion on one end side, and has the fluctuating portion on the other end side.

7. The electrostatic transducer according to claim 1, wherein
the displacement plate is provided in a double-supported beam shape, and the fixed portion is provided so as to sandwich the fluctuating portion.

8. The electrostatic transducer according to claim 1, wherein
the displacement plate is provided in a diaphragm shape, has the fixed portion on a peripheral edge, and has the fluctuating portion inside the peripheral edge.

9. The electrostatic transducer as claimed in claim 6, wherein
the support has an opening in the center, and
the displacement plate is provided so that the fluctuating portion protrudes toward the opening and covers or substantially covers the opening.

10. The electrostatic transducer of claim 6, wherein
the electrostatic transducer is composed of a plurality of electrostatic transducers, which are arranged so that each fluctuating portion is on an inner side, the periphery of each fluctuating portion is surrounded by each support, and each fluctuating portion covers or substantially covers a space surrounded by the supports.

11. The electrostatic transducer according to claim 9, wherein
a gap between the fluctuating portion and the support or a gap between the fluctuating portions of adjacent displacement plates is 10 μm or less.

12. The electrostatic transducer as claimed in claim 1, wherein
the electrostatic transducer is a MEMS device.

13. A method of manufacturing the electrostatic transducer according to claim 1, comprising:
for a laminate obtained by laminating a first layer, a second layer, and a third layer in this order on a surface of a base layer, processing the third layer from a surface side opposite to the second layer to form a structure of the detection means and form one or a plurality of first through-holes penetrating to the second layer;
forming a fourth layer and a fifth layer in this order on the processed surface of the third layer opposite to the second layer;
forming, in the fifth layer, one or a plurality of second through-holes penetrating to the fourth layer from a surface side of the fifth layer opposite to the fourth layer;
removing a portion of the fourth layer and a portion of the second layer through the second through-hole formed in the fifth layer and the first through-hole formed in the third layer, and then closing the second through-hole formed in the fifth layer so that the third layer constitutes the detection means and the detection means is disposed in a vacuum or low-pressure space; and
removing the base layer corresponding to the position of the fluctuating portion so that the first layer constitutes a displacement plate.

14. The method of manufacturing the electrostatic transducer according to claim 13, wherein
the fifth layer is made of silicon, and
the second through-hole formed in the fifth layer is closed by silicon surface migration.
